(19) United States
(12) Patent Application Publication
(10) Pub. No.: US 2011/0039608 A1
(43) Pub. Date: Feb. 17, 2011

(54) MOBILE PHONE DEVICE WITH FUNCTION MODIFICATION BY USER MADE ASSEMBLING

(76) Inventor: MING-HSU HSIAO, Hsin Chuang City (TW)

Correspondence Address: LEONG C. LEI, PMB # 1008, 1839 YGNACIO VALLEY ROAD, WALNUT CREEK, CA, 94598, US

(21) Appl. No.: 12/539,587

(22) Filed: Aug. 11, 2009

(51) Int. Cl. H04M 1/02

(52) U.S. Cl. 455/575.3

(57) ABSTRACT

A mobile phone device allows modification of utilization functions through selective assembling performed by a user. The mobile phone device includes a mobile phone and at least one keyboard. The mobile phone and the keyboard can be selectively assembled together to allow for operation of the mobile phone with the keyboard or separated from each other to allow the mobile phone to be operated in the same way as it was. The keyboard is provided with at least one pushbutton/key arrangement to allow for selection and use of the keyboard according to a desired operation so that versatility and use of the mobile phone can be realized.

### TECHNICAL FIELD OF THE INVENTION

The present invention generally relates to a mobile phone device with function modification by user made assembling, and more particularly to a mobile phone, a 3G phone, a PDA phone, or other portable phones, which can be selectively assembled to a keyboard and separated from the keyboard for independent operation of the phone, and can select different pushbutton/key arrangements for operation of the mobile phone so as to realize versatility of use.

### DESCRIPTION OF THE PRIOR ART

A portable communication device available in the market, such as a mobile phone, a 3G phone, and a PDA phone, is provided with operating/inputting means, which is often of a liquid crystal touch panel or a traditional keypad input. Both types of input have their own advantages and disadvantages. A major disadvantage for both types of input is that they are both a fixed device mounted to a mobile phone and are not fit for software or conditions where a dedicated keyboard is needed, such as playing computer games or on-line games or working as a dedicated keyboard for special software. Up to date, due to constraints imposed by the conventional input means, no mobile phone that can effectively execute operation of playing network based on-line games is available in the market. For the same reason, due to the constraints imposed by the arrangement of pushbuttons/keys on the keyboard, the execution of other special software function is often hindered so that the economic value of the product is lowered.

Further, the conventional construction and operation of mobile phones are of a fixed and unchangeable mode. This is also true for a mobile phone that comprises separate keyboard and display screen, for the keyboard is still fixedly coupled to a main body of the phone and is not separable, such as a flap-cover phone, a foldable phone, or a retractable-cover phone, wherein the keyboard is fixed and un-replaceable and also limits the use of the mobile phone, making it impossible to fully exploit the potential utilization and the economic value of mobile phones. Further improvement is apparently needed in this respect.

### SUMMARY OF THE INVENTION

A primary objective of the present invention is to provide a mobile phone device with function modification by user made assembling, wherein a mobile phone is selectively combined with a keyboard as a unitary device or can be completely detached therefrom to allow the mobile phone to carry out independent operation and wherein the keyboard comprises at least one arrangement of pushbuttons/keys, which can selectively include a regular pushbutton/key arrangement and at least one special pushbutton/key arrangement for the selection by a user.

To achieve the above objective, the present invention provides a device that comprises a mobile phone and at least one keyboard, wherein the mobile phone comprises an operation module (such as a touch panel or a simply constructed keypad) and a signal input/output interface integrated with a phone body and is independently operable for effecting communication with one of the communication protocols including GSM, GRPS, 3G/W-CDMA and EDGE. The keyboard selectively comprises a regular pushbutton/key arrangement and at least one special pushbutton/key arrangement. The mobile phone and the keyboard are combined as a unitary device and electrically connected to each other through a coupling mechanism, whereby the mobile phone and the keyboard are selectively combined together for operation or completely separated from each other.

The coupling mechanism comprises a base and a coupler. The coupler is pivotally mounted to a rear side of the base for rotation and folding and allows the mobile and/or the keyboard to be detachably and respectively coupled to a coupler and/or a base of the coupling mechanism.

Further, multiple pushbutton/key arrangements of different functions are respectively provided on separate keyboard bodies or two pushbutton/key arrangements are respectively formed on opposite surfaces of a single keyboard body.

According to the mobile phone device described above, to use, the mobile phone and the keyboard can be assembled together with the coupling mechanism for operation, or the mobile phone and the keyboard an be separated to allow the mobile phone to be independently operated. Further, with the functions of ready coupling and detaching and/or rotation of the mobile phone and/or the keyboard, the mobile phone device may select a proper pushbutton/key arrangement or set in an assembled form according to various conditions of use so as to realize versatility of combination and use and thus enhancing practicability and convenience.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the present invention.

FIG. 2 is a perspective view of an assembled form of FIG. 1.

FIG. 3 is a perspective view of another assembled form of FIG. 1 for a condition of being upward lifted by 180 degrees.

FIG. 4 is a back side perspective view of FIG. 2.

FIG. 5 is a perspective view showing a collapsed condition of FIG. 1.

FIG. 6 is also a perspective view of a collapsed condition after re-attachment with a mobile phone changing direction.

FIG. 7 is an exploded view of another embodiment of the assembling of a keyboard and a base in accordance with the present invention.

FIG. 8 is a perspective view showing a different pushbutton/key arrangement in accordance with the present invention and an embodiment of combining a mobile phone with a coupler.

FIG. 9 is a perspective view showing a keyboard and a base combined together in accordance with the present invention and also showing pivotal coupling structure for a base and a coupler in a further different embodiment.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

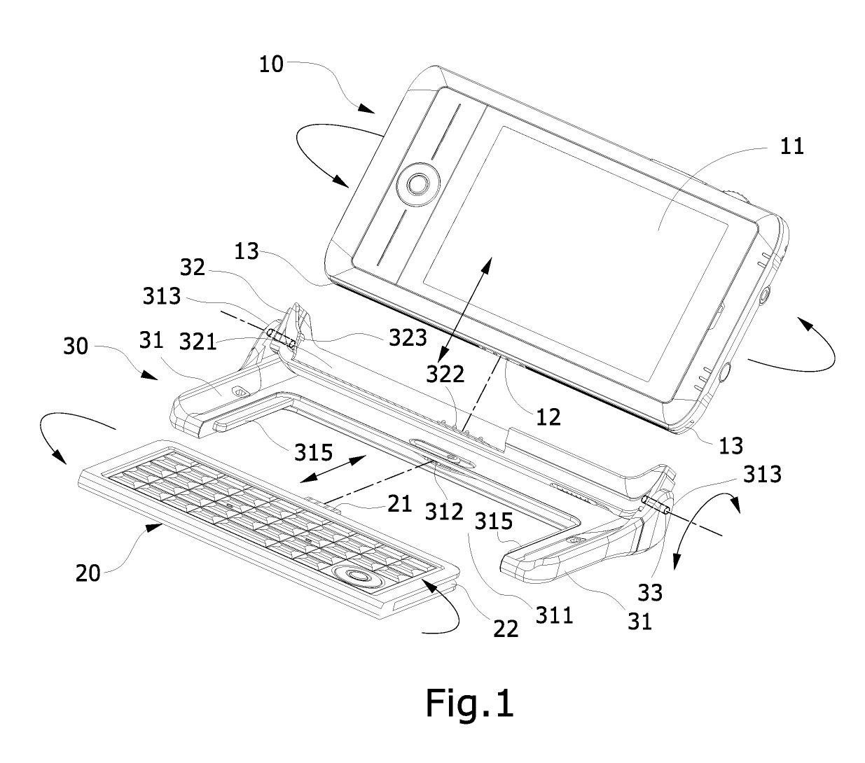

As shown in FIGS. 1 to 6, a mobile phone device constructed in accordance with the present invention features modifiability of utilization functions thereof with selective assembling of parts made by a user. The mobile phone device comprises a mobile phone 10, which is preferably an existing one, a keyboard 20, and a coupling mechanism 30. The mobile phone 10 comprises a phone body on which an operation module and a signal input/output interface are integrally mounted for carrying out independent operation of mobile communication. In the embodiment illustrated, the operation module comprises a touch panel 11 and the signal input/output interface comprises a signal connection port 12 arranged in one side face of a phone enclosure.

The keyboard 20, which has a rear side face from which a terminal carrying section 21 extends and is in electrical connection with a circuit of a pushbutton/key arrangement thereof, comprises a regular pushbutton/key arrangement and at least one special pushbutton/key arrangement.

The coupling mechanism 30 comprises a base 31 and a coupler 32. The coupler 32 is pivotally mounted to an upper portion of a rear side of the base 31 and is rotatable by 180 degrees for folding. The coupler 32 forms a receptacle 321 corresponding to the contour of the side face of the mobile phone 10. The receptacle 321 forms therein a signal connector 322 corresponding to the signal connection port 12 on the side face of the mobile phone 10, whereby the mobile phone 10 is receivable in the receptacle 321 and the signal connector 322 mates the signal connection port 12 to establish electrical connection therebetween. The base 31 has a front side forming a receiving channel 311 (which is preferably a U-shaped receiving channel with/without a bottom) corresponding to a circumferential contour of the keyboard 20. The receiving channel 311 forms therein a terminal carrying section socket 312 corresponding to the terminal carrying section 21 of the keyboard 20, whereby the keyboard 20 is insertable into the receiving channel 311 of the base 31 and the terminal carrying section 21 electrically engage the terminal carrying section socket 312.

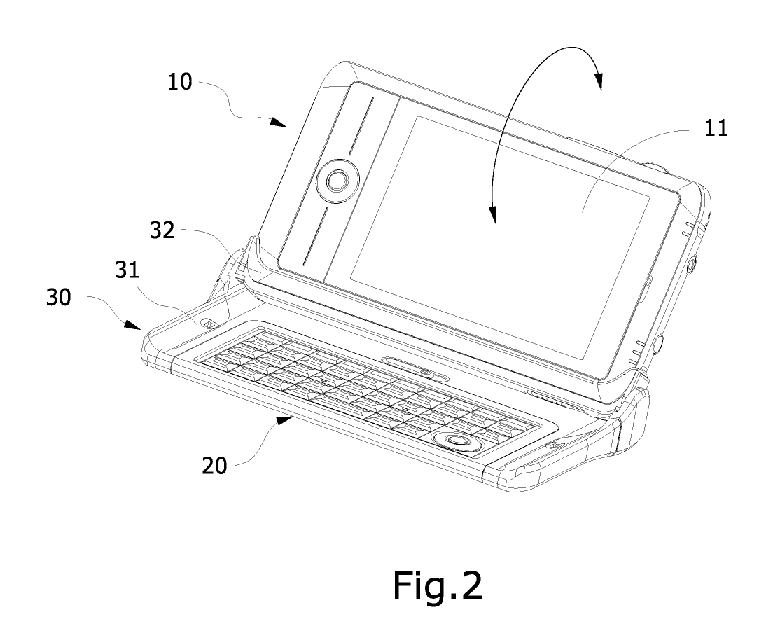

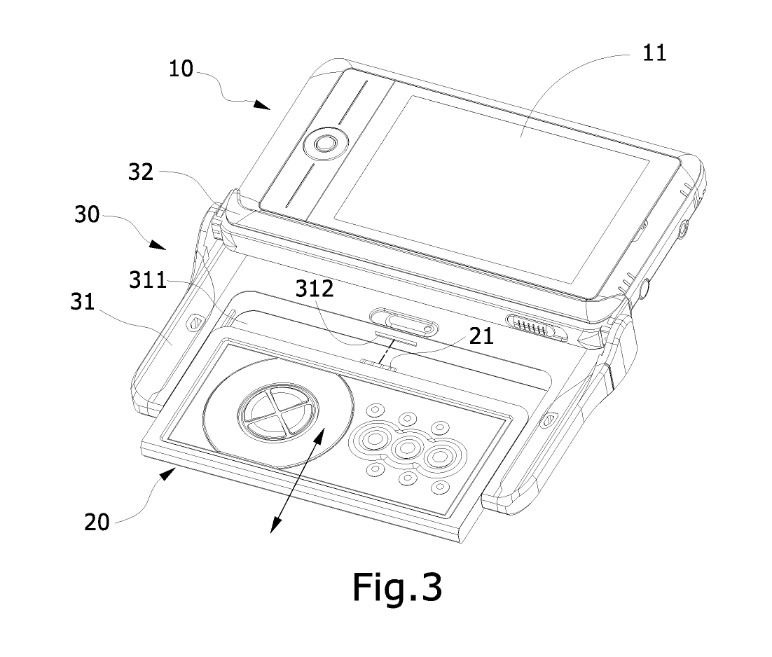

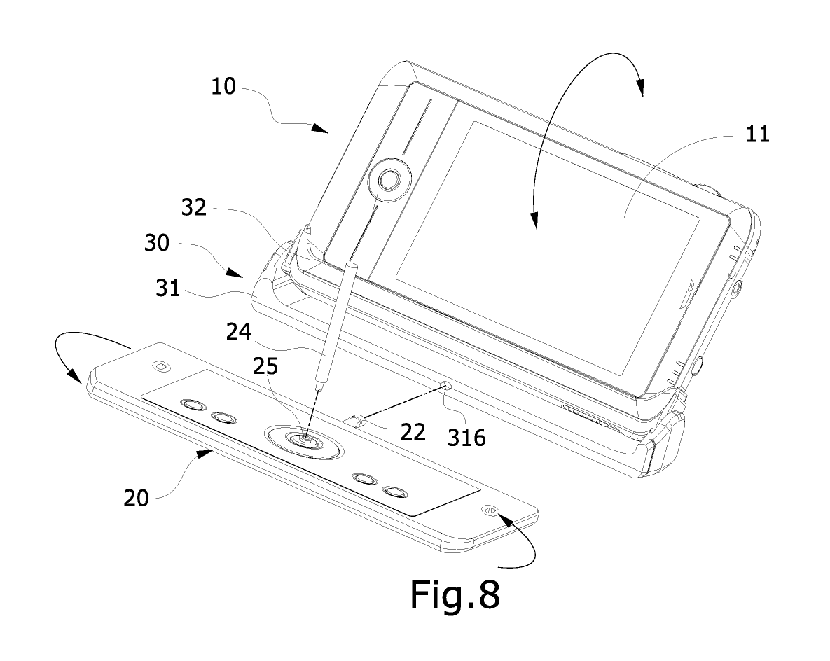

The keyboard 20 comprises a regular pushbutton/key arrangement (see FIG. 2) for operation of communication and input of texts and a special pushbutton/key arrangement for executing games or other functions as shown in FIG. 3, or alternatively as shown in FIG. 8, wherein a detachable stick 24 is jointed to a central bore of a multi-direction pushbutton 25 to form a joystick contained keyboard, or other keyboards, such as a piano keyboard or a digitizer (not shown in the drawings). The keyboard 20 can be constructed so that different pushbutton/key arrangements are provided on individual keyboard bodies, or two pushbutton/key arrangements are set on opposite surfaces of a single keyboard body.

For the keyboard 20 shown in FIG. 1, when the keyboard 20 has two opposite major surfaces respectively forming different pushbutton/key arrangements, the terminal carrying section 21 that is provided on the rear face of the keyboard 20 is centrally set and the terminal carrying section has opposite surfaces each carrying terminals in electrical connection with the respective pushbutton/key arrangement and is engageable with the terminal carrying section socket 312 that is set at a central location of the base 31 in a single face engagement manner. The terminal carrying section 21 of the keyboard 20, due to being set at a central location and only providing single surface engagement, can establish proper electrical connection with the terminal carrying section socket no matter which surface thereof faces up in inserting into the base 31 and will only make the electrical connection with the terminal carrying section socket 312 with the surface thereof facing upward. The pushbutton/key arrangement on the bottom side is not operable due to no electrical connection being established therefor, so that erroneous activation caused by inadvertent contact with the pushbuttons/keys on the bottom side can thus be avoided.

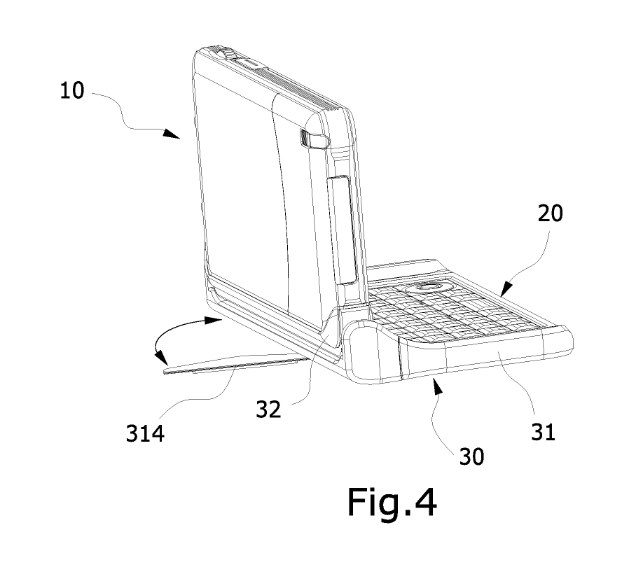

Referring to FIG. 1 again, the signal connector 322 formed on the coupler 32 comprises retractable electrical contacts, whereby when the mobile phone 10 is assembled to the coupler 32, the signal connector 322 undergoes retraction due to contact with contactor terminals or a side wall of the signal connection port 12 of the mobile phone 10, so as to establish tight and secured engagement between the mobile phone 10 and coupler 32. Further, the base 31 forms an upward-extending wing 313 on each lateral end of a rear portion thereof. Each wing 313 has an inside surface that is pivotally coupled to the coupler 32 with a pivot 33. At least one of the pivots 33 is made hollow to allow a signal cable to extend therethrough for electrical connection between a circuit (not shown in the drawings) and the signal connector 322 of the coupler 32. Further, as shown in FIG. 4, the present invention can further comprise a support board 314, which is pivotally mounted to a bottom of the rear face of the base 31. The support board 314 can be withdrawn rearward to provide a film support for preventing the device from tipping over during the use thereof. The support board 314 can be retracted back into the base 31.

To use the mobile phone device of the above described embodiment, the mobile phone 10 and the coupling mechanism 30 of the device are assembled together through engagement between coupling holes 13 formed in opposite sides of the mobile phone 10 and coupling members 323 formed on opposite sides of the coupler 32 and electrical connection established by engagement between the signal connection port 12 and the signal connector 322. Further, the keyboard 20 has two side surfaces defining slide slots 22 that respectively receive rails 315 formed on two inside surfaces of the receiving channel 311 of the base 31 to combine together with the terminal carrying section 21 electrically engaging the terminal carrying section socket 312. In this way, the keyboard 20 can be used to operate the mobile phone 10 (as shown in FIGS. 2 and 3), or the mobile phone 10 can be separated from the coupling mechanism 30 to be operated directly with the touch panel 11 thereof. Further, the keyboard 20 of the device is separable from the base 31 of the coupling mechanism 30 for replacement, so that a user is of the freedom to select the regular pushbutton/key arrangement or the special pushbutton/key arrangement of the keyboard 20 for use, by which versatility and optimization of use can be realized.

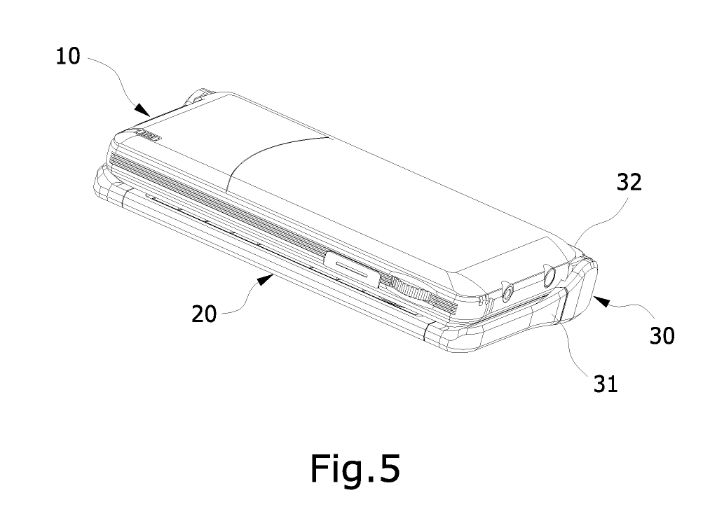

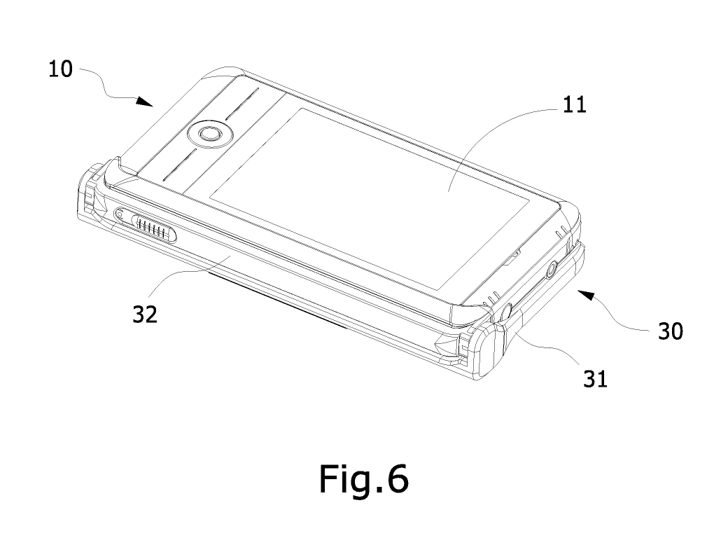

Referring to FIGS. 5 and 6, the device of the present invention as described above is constructed to allow easy combination of a mobile phone 10 with the coupler 32 as a unitary device and/or easy separation. Thus, the mobile phone 10 can be selectively mounted to the coupler 32 by having the surface thereof that carries the touch panel 11 facing the keyboard 20, whereby when the mobile phone 10 is closed to overlap the keyboard 20 (as shown in FIG. 5), the touch panel II and the keyboard 20 are both concealed inside between the two enclosures by which scraping and damaging the screen or inadvertently actuating the keys can be avoided and carrying and storing are facilitated. When the mobile phone 10 is lifted upward by to an angle of 90-120 degrees (as shown in FIG. 2) or 180 degrees (as shown in FIG. 3), both situations allow the mobile phone 10 to be operated with the keyboard 20. Further, when the mobile phone 10 is detached and then re-attached to the coupler 32 with the back thereof facing the keyboard 20 (as shown in FIG. 6), the touch panel 11 is exposed and faces outside so that the touch panel 11 can be directly operated without lifting the keyboard 20.

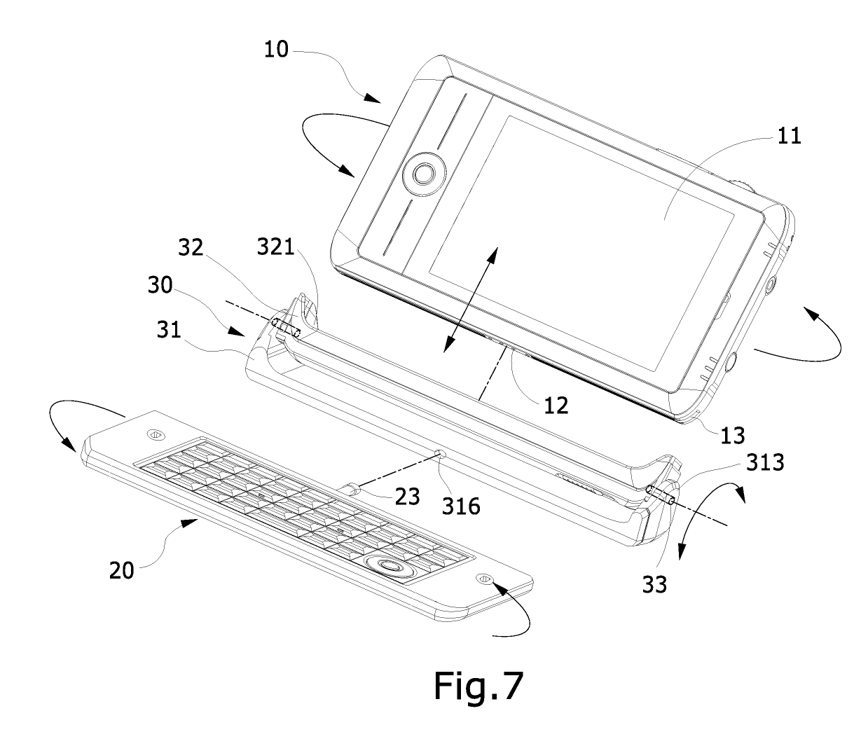

Referring to FIG. 7, a modified embodiment of the present invention is shown. In the instant embodiment, the keyboard 20 is provided with different pushbutton/key arrangements respectively on opposite surfaces thereof and the keyboard 20 forms a hollow joint shaft 23 on a center of a rear surface thereof. With the joint shaft 23 coupled to a receiving bore 316 defined in a front surface of the base 31 of the coupling mechanism 30 to form a unitary device, the keyboard 20 can be overturned by rotation about a center defined by the joint shaft 23 for selection of use. With the hollow joint shaft 23, extension of a signal cable can be made for electrical connection between the circuit of the pushbutton/key arrangement and the signal connector 322 of the coupler 32. To use the device so assembled as described above, the mobile phone 10 is again mounted, in a detachable manner, to the coupling mechanism 30 and the keyboard 20 can be switched to selectively set a top surface or a bottom surface to face upward for selection and use of different pushbutton/key arrangements.

Referring to FIG. 8, another embodiment of the present invention is shown, wherein the mobile phone 10 is integrally formed with (non-detachable from) the coupler 32 of the coupling mechanism 30. The keyboard 20 is constructed with opposite surfaces thereof each forming a different pushbutton/key arrangement and a rear surface thereof forming, at a central location, a hollow joint shaft 23 for being combinable with the front side of the base 31 of the coupling mechanism 30 through the joint shaft 23 (see the structure shown in FIG. 7). Or alternatively, a terminal carrying section 21 is formed on a rear face of the keyboard 20, which can be either single-sided or double-sided and the terminal carrying section 21 is electrically engageable with the terminal carrying section socket 312 formed in the receiving channel 311 of the base 31 (see the structure shown in FIG. 1). In this way, the device is also capable of allowing selection and use of a desired pushbutton/key arrangement through overturning or replacement of the keyboard 20.

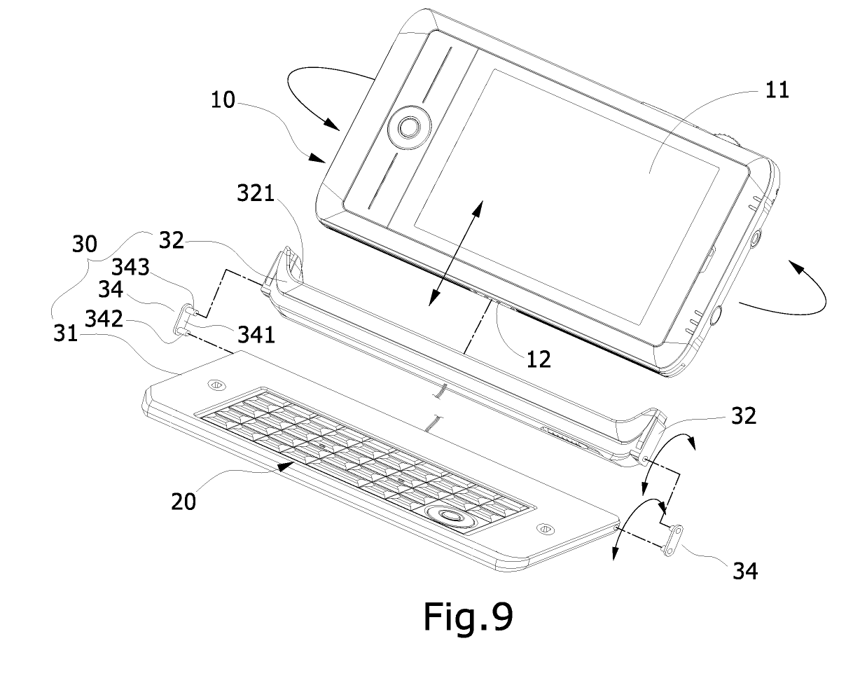

FIG. 9 shows a further embodiment of the present invention, wherein the mobile phone 10 and the coupling mechanism 30 are structured as shown in FIG. 1. The keyboard 20 is integrally formed with the base 31 of the coupling mechanism 30 and the keyboard 20 is provided with different pushbutton/key arrangements on top and bottom surfaces thereof. The coupling mechanism 30 comprises at least one linker 34 that is coupled to the coupler 32 at a rear side of the base thereof. (The linker can be provided at opposite ends or any intermediate location of the coupling mechanism.) The linker 34 comprises a block 341 having opposite ends on which parallel shafts 342, 343 are respectively formed. One 342 of the shafts is rotatably coupled to the base 31 and the other one 343 of the shafts is rotatably coupled to the coupler 32, whereby the mobile phone 10 that is inserted into and coupled to the coupler 32 can be put overlapping the top surface or bottom surface of the keyboard 20 (making a turn of 360 degrees), and the mobile phone 10 can also be detached and re-attached after changing the orientation of the touch panel 11. This also makes it possible to select and use different pushbutton/key arrangements.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A mobile phone device comprising:
a mobile phone, which comprises at least an operation module and a signal input/output interface and is independently operable for effecting communication;
at least one keyboard, which selectively comprises a regular pushbutton/key arrangement for operation of communication and input of texts and at least one special pushbutton/key arrangement for executing games and other functions; and
a coupling mechanism, which couples the mobile phone and the keyboard together and provides electrical connection therebetween, whereby the mobile phone and the keyboard are selectively combined together for operation or separated from each other for independent operation of the mobile phone.

2. The device according to claim 1, wherein the coupling mechanism comprises a base and a coupler, the coupler being pivotally mounted to a rear side of the base for rotation up and down, the coupler being coupled to the mobile phone, the base being coupled to the keyboard.

3. The device according to claim 2, wherein the mobile phone has one side face forming a signal connection port and the coupler forms a receptacle corresponding to a contour of the side face of the mobile phone, the receptacle forming therein a signal connector corresponding to and engageable with the signal connection port of the mobile phone.

4. The device according to claim 3, wherein the coupling mechanism comprises an upward-extending wing formed on each lateral end of a rear portion of the base, each wing being pivotally coupled to the coupler with a pivot to allow the coupler to rotate and fold on an upper side of the rear portion of the base.

5. The device according to claim 3, wherein the coupling mechanism comprises at least one linker that is coupled to the coupler at a rear side of the base thereof, the linker comprising a block having opposite ends on which parallel shafts are respectively formed, one of the shafts being rotatably coupled to the base and the other one of the shafts being rotatably coupled to the coupler, whereby the coupler is allowed to rotate and selectively overlap a top surface or a bottom surface of the base.

6. The device according to claim 3, wherein the signal connector formed on the coupler comprises retractable electrical contacts.

7. The device according to claim 3, wherein the coupling mechanism comprises a support board pivotally mounted to a bottom of a rear face of the base, the support board being withdrawable rearward and outward and retractable back in the bottom of the base.

8. The device according to claim 2, wherein the keyboard comprises a terminal carrying section extending from a rear face thereof and wherein the base of the coupling mechanism forms a receiving channel corresponding to a contour of the keyboard, the receiving channel forming therein a terminal carrying section socket corresponding to the terminal carrying section of the keyboard.

9. The device according to claim 8, wherein the keyboard comprises one pushbutton/key arrangement.

10. The device according to claim 8, wherein the keyboard has opposite surfaces respectively forming different pushbutton/key arrangements.

11. The device according to claim 10, wherein the keyboard comprises a double-sided terminal carrying section for respective engagement with circuits of two pushbutton/key arrangements and wherein the double-sided terminal carrying section is formed at a central location of a rear surface of the keyboard.

12. The device according to claim 2, wherein the keyboard has first and second surfaces respectively forming different pushbutton/key arrangements and wherein a hollow joint shaft is formed at a central location of a rear surface of the keyboard, whereby through rotatable connection of the joint shaft with the base, the keyboard is rotatable about the joint shaft.

13. The device according to claim 2, wherein the keyboard is integrally formed with the base and wherein the keyboard forms different pushbutton/key arrangements on first and second surfaces thereof.

14. The device according to claim 2, wherein the mobile phone is integrally formed with the coupler.
